(19) United States
(12) Patent Application Publication
(10) Pub. No.: US 2006/0076768 A1
(43) Pub. Date: Apr. 13, 2006

(54) Portable aircraft fueling system

(75) Inventor: James P. Kuntz, Spokane, WA (US)

Correspondence Address: L. Grant Foster;HOLLAND & HART LLP, 555 - 17th Street, Suite 3200, P.O. Box 8749, Denver, CO, 80201, US

(73) Assignee: Spokane Industries, Inc.

(21) Appl. No.: 10/963,206

(22) Filed: Oct. 11, 2004

(51) Int. Cl. B60P 3/22

(52) U.S. Cl. 280/830

(57) ABSTRACT

The present invention involves an aircraft fueling apparatus and associated methods of fueling with features that reduce the risk of fuel spills and other accidents. The present invention more specifically contemplates aircraft fueling methods and apparatus that immobilize a fueler when a fueling nozzle is removed from its holster. Moreover, the apparatus described herein may be easily transported from one place to another and operate safely and effectively without external electrical power.

### FIELD OF THE INVENTION

The present invention relates to aircraft equipment, and more particularly to aircraft fueling systems.

### BACKGROUND OF THE INVENTION

One of the most commonly recognized difficulties associated with airplanes and other aircraft is fueling. Aviation fuels, including jet fuel and avgas, are flammable hydrocarbon liquids that can be ignited even at certain ambient conditions, primarily based on temperature and vapor concentration. In addition, hydrocarbons, including avgas and jet fuel, may also present toxic or irritant hazards. At high concentrations, jet fuel, avgas, and other hydrocarbons can affect the nervous system, causing headache, dizziness, and lack of coordination. Exposure to some hydrocarbons may also cause skin irritations. Therefore, it is desirable to prevent or minimize any fuel spills when fueling an aircraft.

Further, fueling aircraft is a common occurrence. Aircraft are typically refueled before every trip by a mobile tank truck. In the past, many accidents occurred as a result of mobile tank truck movement while fuel hoses and nozzles were still engaged with the aircraft. Operators sometimes forgot to disengage the fueling system before driving the truck away.

Therefore, in order to reduce the risk of spills and other accidents, current regulations require locking systems that prevent mobile tank truck movement unless hose nozzles are secured and locked in appropriate holsters. Typical locking systems include an electrical switch that is activated when the fueling nozzle is removed from its holster. The electrical switch electrically locks the brakes of the mobile tank truck, preventing the operator from driving away until the fueling nozzle is returned to its holster.

However, electrical switches and associated components carry the risk of providing a source of ignition in the event of a fuel spill. Therefore, there is a need for an aircraft fueling system that does not depend on electrical components to prevent an operator from moving a fueling truck while the fueling nozzle is removed from its holster.

### SUMMARY OF THE INVENTION

The present invention provides an apparatus and method for fueling an aircraft. According to some embodiments, the apparatus includes a chassis having a plurality of wheels, at least one of the plurality of wheels having a brake, a fuel tank mounted to the chassis, a fuel hose in fluid communication with the fuel tank, a nozzle attached to the fuel hose, a locking nozzle holder, a valve disposed between the fuel tank and the fuel hose, and a multi-operator mechanically connected to the brake, the locking nozzle holder, and the valve. The multi-operator may include a first lever mechanically connected to the brake, a second lever mechanically connected to the locking nozzle holder, and a third lever mechanically connected to the valve.

Each of the first, second, and third levers may articulate between a first position and a second position. The first position of the first lever may comprise a free position and the second position of the first lever may comprise a brake position. The first position of the second lever may comprise a locked nozzle position and the second position of the second lever may comprise a released nozzle position. The first position of the third lever may comprise a closed valve position and the second position of the third lever may comprise an open valve position.

The apparatus may further comprise a connector extending from the second lever such that activation of the second lever from the first position to the second position activates the first and third levers from the first position to the second position.

The apparatus may include a movable rod connected to the second lever, where the locking nozzle holder comprises an outer shell comprising a first hole, an inner member disposed in the outer shell comprising a second hole, the inner member movable between a first locked position and a second released position, and a biasing member biasing the inner member toward the second released position. The movable rod may extend through the first hole in the outer shell and into the second hole of the inner member with the second lever in the first locked position, the rod holding the inner member in the first locked position. The rod is removed from the second hole in the inner member with the second lever in the second position, and the biasing member moves the inner member such that the first and second holes are not aligned. The first, second, and third levers may be locked in the second position until the nozzle is manually inserted into the locking nozzle holder. Manually inserting the nozzle into the locking nozzle holder may facilitate alignment of the first and second holes.

According to some aspects of the invention, the first and third levers are operable between the first and second positions independent of the second lever if the second lever is disposed in the first position.

According to some aspects of the invention, the apparatus may include a first emergency lockout lever mechanically connected to the valve. The valve is biased closed. Actuating the first emergency lockout lever closes the valve and disables the multi-operator. The apparatus may include an emergency lockout lever reset mechanism housed in a lock box. The emergency lockout lever reset mechanism may comprise first and second pulleys arranged in series and connected to each other, a first reset pin, a first cable extending from the valve, around the first pulley, and anchored to the first reset pin, a second cable extending from the multi-operator, around the second pulley, and anchored, and a third cable extending from the first emergency lockout lever to the first reset pin. Actuating the first emergency lockout lever pulls the first reset pin and releases the first cable.

According to some embodiments of the present invention, the apparatus may include a second emergency lockout lever. The emergency lockout lever reset mechanism for such embodiments may further comprise a second reset pin anchoring the second cable, and a fourth cable extending from the second emergency lockout lever to the second reset pin. Actuating the second emergency lockout lever pulls the second reset pin and releases the second cable.

Another aspect of the present invention provides an aircraft fueling controller. The controller comprises a first actuator mechanically connected to a brake of an aircraft fueler, a second actuator mechanically connected to a locking fuel nozzle holster, and a mechanical connector disposed between the first and second actuators such that activation of the second actuator activates the first actuator, but activation of the first actuator does not activate the second actuator. The controller may include a third actuator mechanically connected to a fuel tank valve of the aircraft fueler.

The controller may include a movable rod connected to the second actuator. The locking nozzle holder may comprise an outer shell comprising a first hole, an inner member disposed in the outer shell comprising a second hole, the inner member movable between a first locked position and a second released position, and a biasing member biasing the inner member toward the second released position. The movable rod may extend through the first hole in the outer shell and into the second hole of the inner member with the second actuator in the first locked position, the rod holding the inner member in the first locked position. The locking nozzle holster locks a nozzle from removal in a first locked position.

Activating the second actuator from a first position to a second position removes the rod from the second hole in the inner member, releasing the nozzle holster and the nozzle. The inner member is biased to misalign the first and second holes with the rod removed, locking the second actuator against returning to the first position. Activating the second actuator activates the first lever, setting the brake. Activating the second actuator also activates the third actuator, opening the fuel tank valve. Manually inserting the nozzle realigns the first and second holes, permitting the rod to insert therethrough and the first, second, and third actuators to return to the first position.

Another aspect of the invention provides a method of fueling an aircraft. The method comprises providing a chassis having a plurality of wheels, at least one of the plurality of wheels having a brake, providing a fuel tank mounted to the chassis, providing a fuel hose in fluid communication with the fuel tank, providing a nozzle attached to the fuel hose, providing a locking nozzle holder, providing a valve disposed between the fuel tank and the fuel hose, and providing a multi-operator mechanically connected to the brake, the locking nozzle holder, and the valve. Activating the multi-operator simultaneously releases the nozzle from the locking nozzle holder, sets the brake, and opens the valve, so that fuel may be dispensed to the aircraft. The method may further comprise mechanically locking the brake until the nozzle is replaced in the locking nozzle holder. The method may further comprise providing a first mechanical emergency lockout lever that, when actuated, mechanically closes the valve and disables the multi-operator. A mechanical reset mechanism for the first mechanical emergency lockout lever may be provided and housed within a lock box.

Another aspect of the invention provides a method of fueling an aircraft, the method comprising: locking a fuel nozzle in a fuel nozzle holster, mechanically unlocking the fuel nozzle from the fuel nozzle holster, mechanically setting a brake automatically with the mechanically unlocking of the fuel nozzle, removing the fuel nozzle from the fuel nozzle holster, and dispensing fuel to the aircraft via the fuel nozzle. The method may include mechanically opening a fuel valve automatically when the fuel nozzle is mechanically unlocked. The method may also include mechanically preventing release of the brake until the fuel nozzle is replaced in the fuel nozzle holster. The method may include replacing the fuel nozzle in the fuel nozzle holster, locking the fuel nozzle in the fuel nozzle holster, and releasing the brake. The method may include mechanically closing the valve automatically and disabling the valve from opening upon actuation of a first mechanical emergency lockout lever. The method may include preventing resetting of a valve opening mechanism with a lock box.

### BRIEF DESCRIPTION OF THE DRAWINGS

The accompanying drawings illustrate preferred embodiments of the present invention and are a part of the specification. Together with the following description, the drawings demonstrate and explain the principles of the present invention.

FIG. 1 is a partial side view of an aircraft fueling apparatus according to one embodiment of the present invention.

FIG. 2A is a blown up partial side view assembly drawing of the aircraft fueling apparatus of FIG. 1.

FIG. 2B is a blown up reverse view of a multi-operator apparatus shown in FIG. 2A.

FIG. 3 is a top view of the multi-operator apparatus shown in FIG. 2B.

FIG. 4 is a partial top view of the aircraft fueling apparatus of FIG. 1.

FIG. 5 is a partial top view of the aircraft fueling apparatus of FIG. 1 illustrating an emergency lockout reset mechanism according to one embodiment of the present invention.

FIG. 6 is a blown up view of the emergency lockout reset mechanism shown in FIG. 5.

Throughout the drawings identical reference numbers designate similar, but not necessarily identical elements

### DETAILED DESCRIPTION OF THE PREFERRED EMBODIMENTS

It is a common procedure to fuel an aircraft prior to use. Most aircraft are refueled before each flight by mobile fueling trucks. However, it happens on occasion that an operator will forget to remove the fuel nozzle from the aircraft before moving the fueling truck. Moving a fueling truck with the fuel nozzle still engaged with an aircraft can have serious consequences. Therefore, current regulations require precautions to be taken to prevent mobile fueling trucks or other portable fuelers from moving unless the fuel nozzle is removed from the aircraft and properly stowed in the holster.

Therefore, the present invention involves an aircraft fueling apparatus and associated methods of fueling with features that reduce the risk of fuel spills and other accidents. The present invention more specifically contemplates aircraft fueling methods and apparatus that immobilize a fueler when a fueling nozzle is removed from its holster. Moreover, the apparatus described herein may be easily transported from one place to another and operate safely and effectively without external electrical power.

The fueling apparatus described herein can be used with any aircraft, including without limitation fixed wing aircraft (airplanes) and rotary wing aircraft (helicopters).

As used throughout the specification and claims, the term “lever” is used broadly to mean any mechanical device that can be moved between at least two positions and transmit a force to affect different operations. The words “including” and “having,” as used in the specification, including the claims, have the same meaning as the word “comprising.”

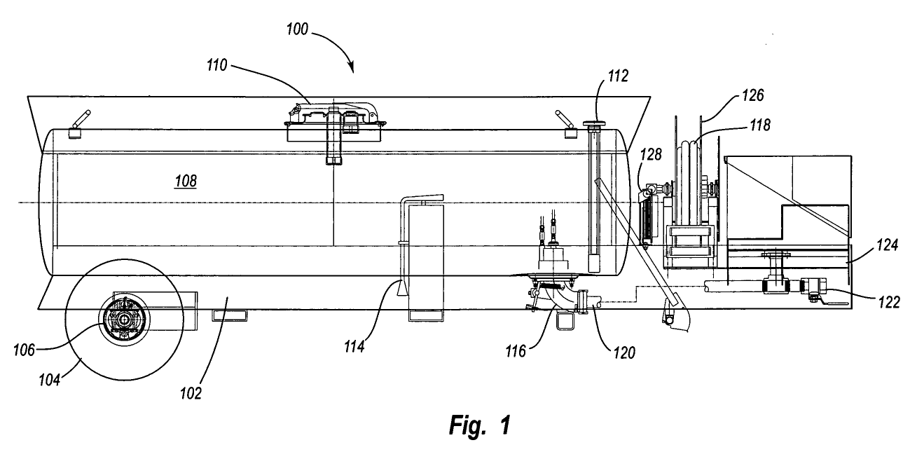

Turning now to the figures, and in particular to FIG. 1 a mobile aircraft fuelling apparatus 100 is shown according to one embodiment of the present invention. The mobile aircraft fuelling apparatus 100 is shown as a trailer that may be hitched to a vehicle. However, the mobile fuelling apparatus 100 may also be self-powered according to some embodiments.

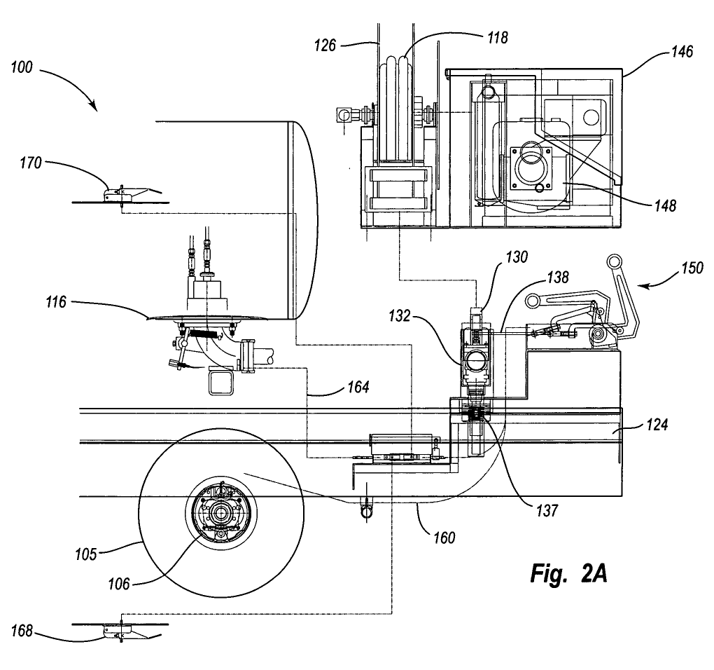

The mobile aircraft fuelling apparatus 100 includes a chassis 102 having a plurality of wheels, for example the first wheel 104 shown and a similar or identical second wheel arranged opposite of the first wheel 104. Two additional similar or identical wheels 105 may be located forward of the first wheel 104 as shown in FIG. 2A to support the chassis 102. One or more of the wheels 104, 105 include a brake 106.

A fuel tank 108 is mounted to the chassis 102 and may hold a supply of aircraft fuel. The fuel tank 108 may be of standard design and includes a self closing manway 110 and a liquid level gauge 112. A fire extinguisher 114 may be attached to the chassis 102 or the fuel tank 108 in case of emergency. The fuel tank 108 also includes a valve such as a self closing valve 116 biased to a closed position to facilitate transfer of fuel from the fuel tank 108.

The self closing valve 116 allows selective fluid communication between the fuel tank 108 and a fuel hose 118 via a fuel pipe 120. The fuel pipe 120 is in fluid communication with both the fuel hose 118 and a tank drain valve 122.

According to the embodiment of FIG. 1, a pump skid 124 is attached to the chassis 102 as well. The pump skid 124 supports various pumping and control apparatus shown in more detail below. The pump skid 124 may also support a hose reel 126. All or a portion of the fuel hose 118 may be wrapped around the hose reel 126. The hose reel 126 and the fuel hose 118 are electrically connected to an adjacent ground reel 128.

The fuel hose 118 includes a nozzle 130 connected to an end thereof as shown in FIG. 2A. A locking nozzle holder such as a locking nozzle holster 132 holds the nozzle 130 until the locking nozzle holster 132 is unlocked. The locking nozzle holster 132 includes an outer shell, which, according to the embodiment of FIGS. 2A-2B, is an outer nozzle cradle 134. The locking nozzle holster 132 also includes an inner member such as inner nozzle cradle 136 nested in the outer nozzle cradle 134. The inner nozzle cradle 136 movably floats within the outer nozzle cradle 134 and is biased by a spring 137 away from the outer nozzle cradle 134. However, the inner nozzle cradle 136 is shown in a first or locked position in FIGS. 2A-2B. The inner nozzle cradle 136 is held in the first or locked position relative to the outer nozzle cradle 134 by a rod 138 extending through a first hole 140 in the outer nozzle cradle 134 and a second hole 142 in the inner nozzle cradle 136. The rod 138 also extends through a third hole 144 in the nozzle 130, locking it in the first or locked position. Therefore, the nozzle 130 is locked within the locking nozzle holster 132 by the rod 138 in the first position shown in FIGS. 2A-2B.

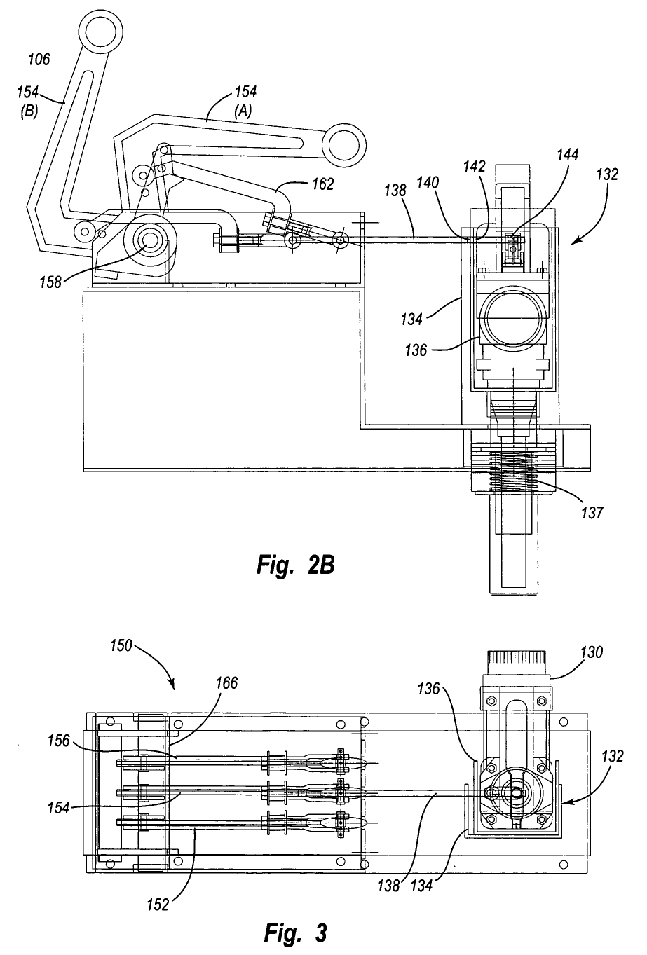

The locking nozzle holster 132 may be released by removing the rod 138 from at least the second hole 142 and the third hole 144. The rod 138 may be moved by a multi-operator 150. The multi-operator 150 is mechanically connected to the brake 106, the locking nozzle holster 132, and the self closing valve 116 to facilitate disabling the aircraft fuelling apparatus 100 when the nozzle 130 is released from the locking nozzle holster 132 without any electronics. Some use of electronics may also be used if desired, but it is not necessary according to the embodiment shown to use electronics to disable the aircraft fuelling apparatus 100. The multi-operator 150 is shown from a top view in FIG. 3 and may include one or more actuators, for example first, second, and third levers 152, 154, 156, respectively. According to the embodiment of FIG. 3, each of the levers 152, 154, 156 is mounted on a common shaft 158. The levers 152, 154, 156 may thus rotate about the common shaft 158 to multiple positions.

The first lever 152 may be mechanically connected to the brake 106 (FIG. 2A) by a brake cable 160 (FIG. 2A). Accordingly, the first lever 152 may articulate between a first or free position as shown in FIGS. 1-3 in which the brake 106 is released, and a second position in which the brake is set.

The second lever 154 is mechanically connected to the locking nozzle holster 132. As shown in FIGS. 2B and 3, the second lever 154 is mechanically connected to the locking nozzle holster 132 via attachment to the rod 138. The second lever 154 may articulate between a first or locked nozzle position and a second or released nozzle position. FIG. 2B illustrates the second lever 154 in both the locked and released positions. The second lever 154 at (A) represents the second lever 154 at the locked position with the rod 138 extending through each of the first, second, and third holes 140, 142, 144. The second lever 154 at (B) represents the second lever 154 at the released nozzle position. The rod 138 is preferably removed from the second and third holes 142, 144, and rests in the first hole 140 when the second lever 154 is in the released nozzle position. A connecting arm 162 may connect between the second lever 154 and the rod 138. The nozzle 130 may be used to dispense fuel into an aircraft when it is released from the locking nozzle holster 132.

When the rod 138 is removed from the second and third holes 142, 144, the spring 137 moves the inner nozzle cradle 136 relative to the outer nozzle cradle 134, lifting out the nozzle 130 and misaligning the first and second holes 140, 142. Therefore, the rod 138 may not be reinserted through the second and third holes 142, 144, nor can the second lever 154 be returned to the first or locked nozzle position, if the nozzle 130 is released from the cradle 132.

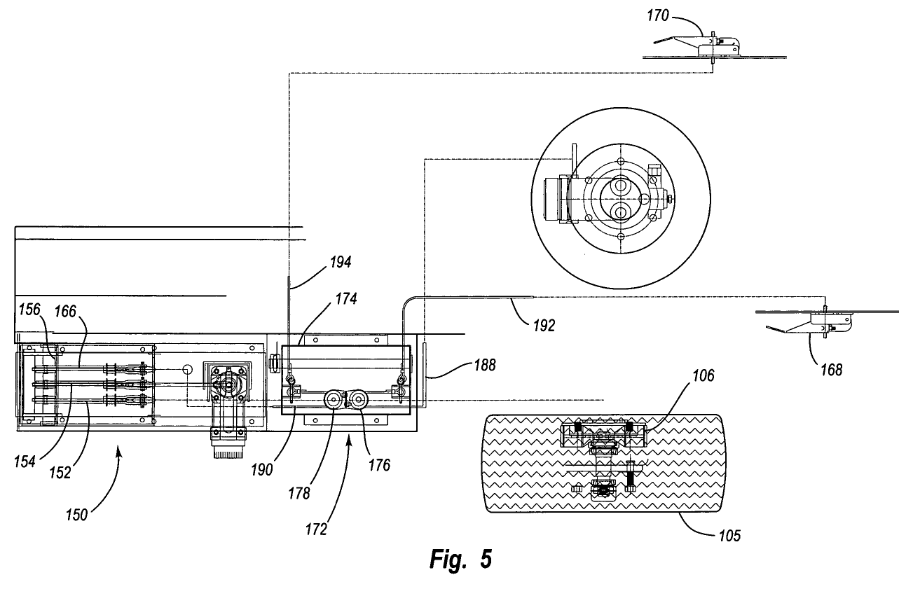

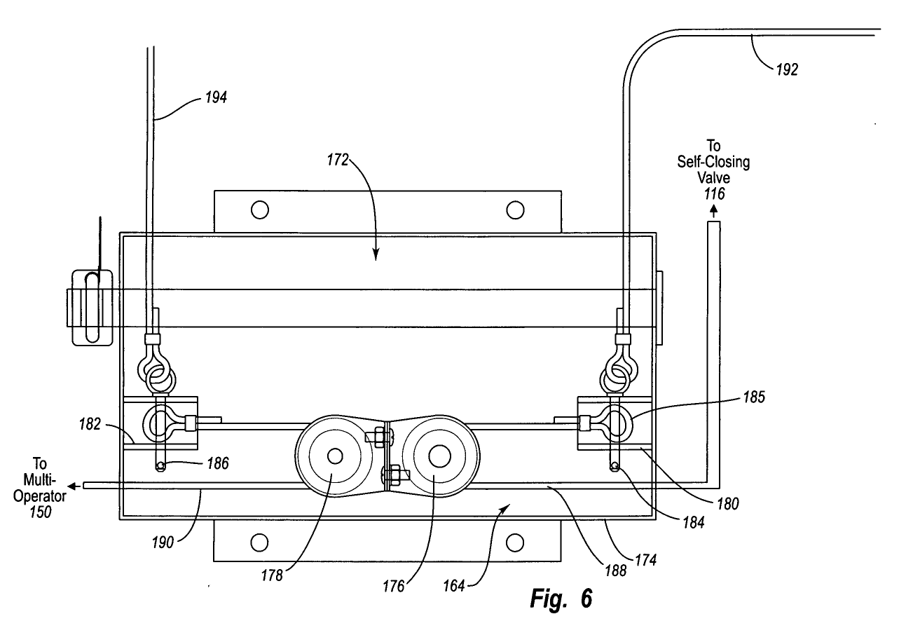

The third lever 156 is mechanically connected to the self closing valve 116 (FIG. 2A). The self closing valve 116 (FIG. 2A) remains closed until the third lever 156 is moved from a first or closed valve position to a second or open valve position. A self closing valve cable 164 (FIG. 2A) extending between the self closing valve 116 (FIG. 2A) and the third lever 156 opens the self closing valve 116 (FIG. 2A) when the second lever 154 is articulated from the first to the second position. As discussed in more detail below with reference to FIGS. 5-6, the self-closing valve cable 164 (FIG. 2A) may comprise multiple components according to some embodiments.

The first and third levers 152, 156 may be activated manually independent of one another and independent of the second lever 154, as long as the second lever 154 is in the first position. Accordingly, with the second lever 154 in the first position, the first and third levers 152, 154 may be manipulated between the first and second positions, or anywhere between the first and second positions. However, the second lever 154 includes a connector such as a pin 166 that contacts the first and third levers 152, 156 and automatically moves and activates them from the first to the second position when the second lever 154 is moved from the first to the second position. Therefore, if the second lever 154 is moved from the first to the second position, the brake 106 (FIG. 2A) of the wheels 105 (FIG. 2A) are set, and the aircraft fueling apparatus 100 (FIG. 2A) may not move. The brake 106 (FIG. 2A) may not be released at least until the nozzle 130 is replaced in the locking nozzle holster 132 and the inner nozzle cradle 136 is depressed against the spring 137 to realign the first and second holes 140, 142. Therefore, accidents are greatly reduced as the aircraft fuelling apparatus 100 (FIG. 2A) is not movable unless the nozzle 130 is locked securely in the locking nozzle holster 132. Similarly, the self-closing valve 116 (FIG. 2A) is held open in the second position at least until the nozzle 130 is locked in the locking nozzle holster 132.

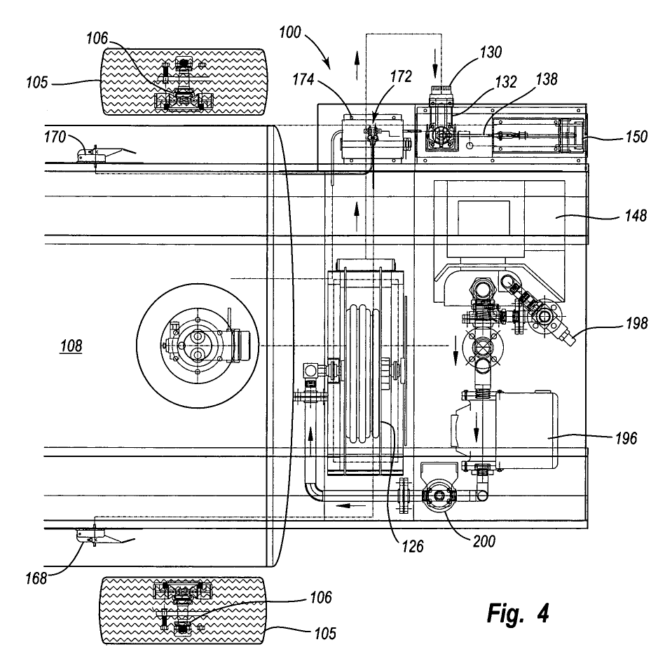

However, in the event of emergency or other event, there may be a need to close the self-closing valve 116 (FIG. 2A) even when the multi-operator 150 is in the second position. Therefore, according to some embodiments of the present invention there may be at least one emergency lockout lever. The embodiment of FIG. 4 illustrates first and second emergency lockout levers 168, 170 on opposite sides of the aircraft fuelling apparatus 100.

The first and second emergency lockout levers 168, 170 are directly or indirectly mechanically connected to the self-closing valve 116 (FIG. 2A). Accordingly, when either of the first or second emergency lockout levers 168, 170 is activated, the self-closing valve 116 (FIG. 2A) closes, stopping the flow of any fuel from the fuel tank 108. Actuating one of the first or second emergency lockout levers 168, 170 also mechanically disables the multi-operator 150, so that the self-closing valve 116 (FIG. 2A) may not be reopened by the multi-operator 150.

The self-closing valve 116 (FIG. 2A) may only be reopened, and the multi-operator 150 may only be re-enabled, by resetting the emergency lockout levers 168, 170. Resetting may be facilitated by a reset mechanism 172 that is discussed in more detail below with reference to FIG. 5. The reset mechanism 172 is housed in a lock box 174 that preferably only authorized personnel may have access to. Therefore, in the event of an emergency or other event in which someone activates one of the emergency lockout levers 168, 170, the aircraft fueling apparatus 100 must remain in place with the self closing valve 116 (FIG. 2A) closed so that, if necessary, the aircraft fueling apparatus 100 may be examined before any changes are made to the aircraft fueling apparatus 100.

The reset mechanism 172 is shown in some detail in FIGS. 5-6. As shown in FIG. 5-6, the reset mechanism 172 includes first and second pulleys 176, 178 arranged in series and connected to each other. The first and second pulleys 176, 178 may be free floating. Inside the lock box 174 may be first and second brackets 180, 182, receptive of first and second reset pins 184, 186, respectively.

As shown in FIGS. 5-6, the self closing valve cable 164 (FIG. 2A) may comprise multiple components as mentioned above. The self closing valve cable 164 (FIG. 2A) may include a first cable 188 extending from the self closing valve 116 (FIG. 2A), around the first pulley 176, and anchor to the first reset pin 184. The first cable 188 may be looped as shown, with the first reset pin 184 extending through the loop 185 and at least partially enclosed by the first mounting bracket 180. The self closing valve cable 164 (FIG. 2A) may also include a second cable 190 extending from the multi-operator 150 (FIG. 2A), around the second pulley 178, and anchor to the second reset pin 186. Thus, as the third lever 156 is activated under normal conditions, the first and second cables 188, 190—along with the pulleys 176, 178—cooperate to open and close the self-closing valve 116.

However, the multi-operator 150 may be disabled and the self closing valve 116 closed by activating one of the emergency lockout levers 168, 170. A third cable 192 may be attached to the first emergency lockout lever 168 and extend to the first reset pin 184. Accordingly, actuating the first lockout lever 168 pulls the first reset pin 184 from the first mounting bracket 180, releasing the first cable 188 connected to the self closing valve 116. When the first cable 188 is released, there is no longer a mechanical connection between the multi-operator 150 and the self closing valve 116. The multi-operator 150 is thus disabled and the self closing valve 116 closes. The self closing valve 116 may only be reopened, and the multi-operator 150 re-enabled, by reinserting the first reset pin 184 into the first mounting bracket 180 and through the loop 185 of the first cable 188. Preferably there is only access to the reset mechanism 172 by the lock box 174, which may have limited personnel availability.

Similarly, a fourth cable 194 may be attached to the second emergency lockout lever 170 and extend to the second reset pin 186. Accordingly, actuating the second lockout lever 170 pulls the second reset pin 186 from the second mounting bracket 182, releasing the second cable 190 connected to the multi-operator 150. When the second cable 190 is released, there is no longer a mechanical connection between the multi-operator 150 and the self closing valve 116. The multi-operator 150 is thus disabled and the self closing valve 116 closes. The self closing valve 116 may only be reopened, and the multi-operator 150 (FIG. 2A) re-enabled, by reinserting the second reset pin 186 into the second mounting bracket 182 and through the loop of the second cable 190.

It will be understood by those of skill in the art having the benefit of this disclosure that some embodiments may have only one emergency lockout lever. In such a case, one of the first or the second mounting brackets 180, 182, one of the first or second reset pins 184, 186, and one of the third of fourth cables 192, 194 may be omitted. Likewise, one of the first or second cables 188, 190 may be permanently anchored without any removable pins.

Returning to FIGS. 2A and 4, the hose reel 126 is shown in relation to a pump box assembly 146, which includes a fuel pump 148. The pump box assembly 146 is located on the pump skid 124. The pump skid 124 may also include a flow meter 196, a pump pressure relief valve 198, and a fuel filter/dryer 200. Associated piping as shown may also be used to facilitate dispensing of fuel from the nozzle 130 to an aircraft when the nozzle 130 is released from the locking nozzle holster 132. The pump assembly 146 and associated piping may be purchased from a variety of manufacturers.

The preceding description has been presented only to illustrate and describe the invention. It is not intended to be exhaustive or to limit the invention to any precise form disclosed. Many modifications and variations are possible in light of the above teaching.

The preferred embodiments were chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. An aircraft fueling apparatus, comprising:
a chassis having a plurality of wheels, at least one of the plurality of wheels having a brake;
a fuel tank mounted to the chassis;
a fuel hose in fluid communication with the fuel tank;
a nozzle attached to the fuel hose;
a locking nozzle holder;
a valve disposed between the fuel tank and the fuel hose;
a multi-operator mechanically connected to the brake, the locking nozzle holder, and the valve.

2. An aircraft fueling apparatus according to claim 1 wherein the multi-operator comprises:
a first lever mechanically connected to the brake;
a second lever mechanically connected to the locking nozzle holder;
a third lever mechanically connected to the valve.

3. An aircraft fueling apparatus according to claim 2 wherein each of the first, second, and third levers articulate between a first position and a second position.

4. An aircraft fueling apparatus according to claim 3 wherein:
the first position of the first lever comprises a free position and the second position of the first lever comprises a brake position;
the first position of the second lever comprises a locked nozzle position and the second position of the second lever comprises a released nozzle position;
the first position of the third lever comprises a closed valve position and the second position of the third lever comprises an open valve position.

5. An aircraft fueling apparatus according to claim 4, further comprising a connector extending from the second lever such that activation of the second lever from the first position to the second position activates the first and third levers from the first position to the second position.

6. An aircraft fueling apparatus according to claim 4, further comprising:
a movable rod connected to the second lever;
wherein the locking nozzle holder comprises:
an outer shell comprising a first hole;
an inner member disposed in the outer shell comprising a second hole, the inner member movable between a first locked position and a second released position;
a biasing member biasing the inner member toward the second released position;
wherein the movable rod extends through the first hole in the outer shell and into the second hole of the inner member with the second lever in the first locked position, the rod holding the inner member in the first locked position.

7. An aircraft fueling apparatus according to claim 6 wherein the rod is removed from the second hole in the inner member with the second lever in the second position, and the biasing member moves the inner member such that the first and second holes are not aligned.

8. An aircraft fueling apparatus according to claim 6 wherein the first, second, and third levers are locked in the second position until the nozzle is manually inserted into the locking nozzle holder.

9. An aircraft fueling apparatus according to claim 8 wherein manually inserting the nozzle into the locking nozzle holder aligns the first and second holes.

10. An aircraft fueling apparatus according to claim 4 wherein the first and third levers are operable between the first and second position independent of the second lever if the second lever is disposed in the first position.

11. An aircraft fueling apparatus according to claim 1, further comprising a first emergency lockout lever mechanically connected to the valve, wherein the valve is biased closed, and actuating the first emergency lockout lever closes the valve and disables the multi-operator.

12. An aircraft fueling apparatus according to claim 11, further comprising an emergency lockout lever reset mechanism housed in a lock box.

13. An aircraft fueling apparatus according to claim 12 wherein the emergency lockout lever reset mechanism comprises:
first and second pulleys arranged in series and connected to each other;
a first reset pin;
a first cable extending from the valve, around the first pulley, and anchored to the first reset pin;
a second cable extending from the multi-operator, around the second pulley, and anchored;
a third cable extending from the first emergency lockout lever to the first reset pin;
wherein actuating the first emergency lockout lever pulls the first reset pin and releases the first cable.

14. An aircraft fueling apparatus according to claim 13, further comprising:
a second emergency lockout lever;
wherein the emergency lockout lever reset mechanism further comprises:
a second reset pin anchoring the second cable;
a fourth cable extending from the second emergency lockout lever to the second reset pin;
wherein actuating the second emergency lockout lever pulls the second reset pin and releases the second cable.

15. An aircraft fueling apparatus according to claim 12 wherein the emergency lockout lever reset mechanism comprises:
first and second pulleys arranged in series and connected to each other;
a first reset pin;
a first cable extending from the multi-operator, around the first pulley, and anchored to the first reset pin;
a second cable extending from the valve, around the second pulley, and anchored;
a third cable extending from the first emergency lockout lever to the first reset pin;
wherein actuating the first emergency lockout lever pulls the first reset pin and releases the first cable.

16. An aircraft fueling controller, comprising:
a first actuator mechanically connected to a brake of an aircraft fueler;
a second actuator mechanically connected to a locking fuel nozzle holster;
a mechanical connector disposed between the first and second actuators such that activation of the second actuator activates the first actuator, but activation of the first actuator does not activate the second actuator.

17. An aircraft fueling controller according to claim 16, further comprising a third actuator mechanically connected to a fuel tank valve of the aircraft fueler.

18. An aircraft fueling controller according to claim 17, further comprising:
a movable rod connected to the second actuator;
wherein the locking nozzle holster comprises:
an outer shell comprising a first hole;
an inner member disposed in the outer shell comprising a second hole, the inner member movable between a first locked position and a second released position;
a biasing member biasing the inner member toward the second released position;
wherein the movable rod extends through the first hole in the outer shell and into the second hole of the inner member with the second actuator in the first locked position, the rod holding the inner member in the first locked position.

19. An aircraft fueling controller according to claim 18 wherein the locking nozzle holster locks a nozzle from removal in the first locked position.

20. An aircraft fueling controller according to claim 19
wherein activating the second actuator from a first position to a second position:
removes the rod from the second hole in the inner member, releasing the nozzle holster and the nozzle;
wherein the inner member is biased to misalign the first and second holes with the rod removed, locking the second actuator against returning to the first position;
activates the first actuator and sets the brake;
activates the third actuator and opens the fuel tank valve.

21. An aircraft fueling controller according to claim 20 wherein manually inserting the nozzle realigns the first and second holes, permitting the rod to insert therethrough and the first, second, and third actuators to return to the first position.

22. A method of fueling an aircraft, comprising:
providing a chassis having a plurality of wheels, at least one of the plurality of wheels having a brake;
providing a fuel tank mounted to the chassis;
providing a fuel hose in fluid communication with the fuel tank;
providing a nozzle attached to the fuel hose;
providing a locking nozzle holder;
providing a valve disposed between the fuel tank and the fuel hose;
providing a multi-operator mechanically connected to the brake, the locking nozzle holder, and the valve;
activating the multi-operator, simultaneously releasing the nozzle from the locking nozzle holder, setting the brake, and opening the valve.
dispensing fuel to the aircraft.

23. A method of fueling an aircraft according to claim 22, further comprising mechanically locking the brake until the nozzle is replaced in the locking nozzle holder.

24. A method of fueling an aircraft according to claim 22, further comprising providing a first mechanical emergency lockout lever that, when actuated, mechanically closes the valve and disables the multi-operator.

25. A method of fueling an aircraft according to claim 24, further comprising providing a mechanical reset mechanism for the first mechanical emergency lockout lever housed within a lock box.

26. A method of fueling an aircraft, comprising:
locking a fuel nozzle in a fuel nozzle holster;
mechanically unlocking the fuel nozzle from the fuel nozzle holster;
mechanically setting a brake automatically with the mechanically unlocking of the fuel nozzle;
removing the fuel nozzle from the fuel nozzle holster;
dispensing fuel to the aircraft via the fuel nozzle.

27. A method of fueling an aircraft according to claim 26, further comprising mechanically opening a fuel valve automatically with the mechanically unlocking of the fuel nozzle.

28. A method of fueling an aircraft according to claim 26, further comprising mechanically preventing release of the brake until the fuel nozzle is replaced in the fuel nozzle holster.

29. A method of fueling an aircraft according to claim 28, further comprising:
replacing the fuel nozzle in the fuel nozzle holster;
locking the fuel nozzle in the fuel nozzle holster;
releasing the brake.

30. A method of fueling an aircraft according to claim 26, further comprising:
mechanically closing the valve automatically and disabling the valve from opening upon actuation of a first mechanical emergency lockout lever.

31. A method of fueling an aircraft according to claim 30, further comprising preventing resetting of a valve opening mechanism with a lock box.

32. An aircraft fueling apparatus, comprising:
a chassis having a plurality of wheels, at least one of the plurality of wheels having a brake;
a fuel tank mounted to the chassis;
a fuel hose in fluid communication with the fuel tank;
a nozzle attached to the fuel hose;
a locking nozzle holder;
a valve disposed between the fuel tank and the fuel hose;
a multi-operator mechanically connected to the brake, the locking nozzle holder, and the valve
wherein the multi-operator comprises:
a first lever mechanically connected to the brake;
a second lever mechanically connected to the locking nozzle holder;
a third lever mechanically connected to the valve;
wherein actuation of the second lever automatically actuates the first and second lever, but actuation of the first or third levers does not automatically actuate the second lever.
